(19) United States
(12) Patent Application Publication
(10) Pub. No.: US 2025/0122105 A1
(43) Pub. Date: Apr. 17, 2025

(54) METHOD FOR TREATING WASTE WATERS AND RESIDUE SLUDGE BY MEANS OF CARBONATION AND DECARBONATION IN A CHEMICAL INSTALLATION FOR NITRIDATION IN A MOLTEN SALT BATH

(71) Applicant: Hydromecanique Et Frottement, Andrezieux-Boutheon (FR)

(72) Inventors: Frédéric Garcia, SAINT LAURENT D'AGNY (FR); Christophe Heau, SAINT-JEAN-BONNEFONDS (FR)

(21) Appl. No.: 18/834,072

(22) PCT Filed: Oct. 31, 2022
(86) PCT No.: PCT/FR2022/052055

§ 371 Date: Jul. 29, 2024

(30) Foreign Application Priority Data
Jan. 31, 2022 (FR) 2200858

(51) Int. Cl. C02F 1/52; C02F 11/00; C02F 101/20; C02F 103/16; C23C 8/50

(52) U.S. Cl. CPC C02F 1/5245; C02F 11/00; C02F 2101/20; C02F 2103/16; C23C 8/50

(57) ABSTRACT

The present invention relates to a method for treating waste waters (E_{L}), and/or residue sludge(E_{S}) from an oxidation bath, in an installation (10) for nitridation in a molten salt bath, comprising a nitridation bath (11), an oxidation bath (12), and a stop bath (13). The treatment method comprises a method A of decarbonation for recovering oxidation salts, and a method B of carbonation for recovering carbonate salts.

### TECHNICAL FIELD OF THE INVENTION

The present invention relates to a method for treating waste waters, and residue sludge from the oxidation bath, to recover oxidation salts, carbonate salts and water, in a chemical installation for nitridation in a molten salt bath.

### PRIOR ART

In automotive, aeronautical, or industrial applications, the mechanical parts are generally subjected to significant stresses in operation.

Conventionally, the mechanical parts can receive treatments of a physico-chemical nature, making it possible to improve some of their properties, among which appear, in particular, friction properties, resistance to wear, resistance to fatigue, resistance to seizing, or also resistance to corrosion.

A treatment known from the prior art is nitridation. Nitridation consists of immersing a ferrous metal part in a medium which is able to transfer nitrogen, which can be, in particular, a molten salt bath. In the present text, nitridation also includes nitrocarburising, which is a variant of nitridation, in which carbon diffuses in the part in addition to nitrogen. The ARCOR® method, designed and implemented by the Applicant, is a preferred example of the nitridation method.

In reference to FIG. 1 which represents an installation for nitridation according to the prior art, such an installation 1 comprises several successive baths, among which, from upstream to downstream, a nitridation bath 2, an oxidation bath 3, and a stop bath 4, also called “water stop bath”. Upstream of the nitridation bath, a degreasing bath 5, or one or more washing baths 6, and a drying device 7 such as an oven are usually provided. Downstream of the stop bath 4, one or more washing baths 8, and a device 9 for drying parts are usually provided.

The mechanical parts are first degreased, washed, and heating by successively passing into the degreasing bath 5, into the washing baths 6, and into the drying device 7, respectively. The parts are then immersed in the nitridation bath 2, which is a molten salt bath, containing, among others, carbonates. As needed, adding regeneration salts will lead to the transformation of carbonates into cyanates, which are reactive species. Nitrogen (and optionally carbon) diffuses in the parts and precipitates in the form of nitrides, which leads to the formation of a combination layer mainly comprising iron nitrides (or other alloy elements), and an underlying diffusion zone, in which nitrogen is present between the iron atoms (solid solution) or nitrogen reacts with the alloy elements contained in steel to form nitrides.

The combined effect of the combination layer and the diffusion layer makes it possible to obtain a nitrided part having good friction properties, as well as an excellent resistance to wear.

After nitridation, the parts are immersed in the oxidation bath 3 comprising oxidising salts, typically hydroxides and/or nitrates, to improve their resistance to corrosion and give them a uniform black appearance.

After oxidation, the parts are immersed in the stop bath 4 which contains cold water, which stops oxidation, then are cleaned by several successive washes in the washing baths 8, before being dried in the drying device 9, then discharged.

For certain treatments, the oxidation step is not required, the parts are transferred from the nitridation bath directly to a dedicated stop bath. The waters from this stop bath are nitridation salt-enriched (and no longer in oxidation salts).

Although nitridation is an effective method for improving the properties of the mechanical parts, it has the disadvantage of generating liquid and solid waste (sometimes called effluents), and requires water. This represents a significant ecological impact, and can cause high production costs, in particular due to the treatment of waste described below.

During an ARCOR treatment, nitridation salts are entrained by the parts and pollute the oxidation bath, then salts from the oxidation bath are entrained and transferred into the stop bath. Secondary chemical reactions also create sludge/waste even in treatment baths (nitridation and oxidation).

It is also possible that the line is used alternatively with or without oxidation and that the stop bath thus alternatively serves as a stop bath for nitridation then for oxidation. Nitridation salts and oxidation salts are thus alternatively transferred into the same stop bath.

This waste is represented in FIG. 1. These are solid effluents E_{S}, but also liquid effluents E_{L}.

The solid effluents E_{S} are called “residue sludge”. They are mainly collected in the oxidation bath 3 and in the nitridation bath 2 (after performing the method), and are generally sent into salt mines to be treated and stored there. They contain insoluble species and salt. For the two types of salts (nitridation salt and oxidation salt), metals and metal oxides coming from the parts to be treated (iron and alloy metals) constitute insolubles. For the oxidation salt, carbonates constitute a large portion of insolubles. Residue sludge is physically removed during regular maintenance operations.

The liquid effluents E_{L} are called “waste waters”. They are collected at the outlet of the stop bath 4, and are generally sent into purification stations or managed by companies specialising in waste treatment.

In addition, the purchase costs of raw materials are themselves also relatively high, it is therefore interesting to optimise their consumption.

### BRIEF DESCRIPTION OF THE INVENTION

Faced with this situation, the Applicant has therefore sought a solution to reduce the environmental impact and to control the costs associated with nitridation methods.

The Applicant has quite specifically focused their research on reducing waste, and limiting waste for both renewable resources such as water, and non-renewable resources, such as raw materials used in nitridation and oxidation baths, i.e. nitridation and oxidation salts.

The Applicant has arrived at developing a treatment method which makes it possible to overcome all of the abovementioned disadvantages, and this, without modifying the architecture of the nitridation chains, therefore being able to be implemented on current lines.

To this end, the invention proposes a method for treating waste waters (E_{L}), and/or residue sludge(E_{S}) from the oxidation bath, to recover oxidation salts and carbonates, in at least one installation for nitridation in a molten salt bath comprising a nitridation bath, an oxidation bath, and a stop bath, the treatment method comprising:
a method A of decarbonation comprising the following steps:
   decarbonation of waste waters and/or residue sludge by precipitation of carbonate ions CO₃²⁻,
   separation of a liquid phase containing oxidation salts and of a solid phase
   containing a carbonate precipitate,
   recovery, on the one hand, of oxidation salts, and on the other hand, of carbonates,
a method B of carbonation comprising the following steps:
   transformation of hydroxide ions OH⁻ of waste waters and/or of residue sludge into carbonate ions CO₃²⁻,
   separation of water and of carbonate salts formed by the carbonate ions and the metal cations from the oxidation salts,
   recovery of carbonate salts.

By selecting either of these two methods A and B, it is possible to orient the recovery or the recycling to the salts, which will be needed most at some point in the future, or for which the purchase cost is the greatest.

According to the treatment method of the invention, the waste waters at the outlet of the stop bath and the residue sludge from the oxidation bath are treated, and preferably recycled, in order to supply the oxidation bath with oxidation salts, to supply the nitridation bath with carbonate salts, which are a component of nitridation salts, and advantageously, to supply the stop bath and/or the washing baths with water when a step of recycling water, such as described below is carried out.

Carbonate ions CO₃²⁻ come from the entrainment of the salts from the nitridation salts and are formed in the reaction medium. They constitute a “contaminating” species for the oxidation bath. The decarbonation step aims to remove the carbonates by precipitation, in order to be able to isolate the oxidising species (nitrates and/or hydroxides) necessary for the correct operation of the oxidation bath.

After solid/liquid separation, the oxidation salts are recovered. The latter can thus be reinjected into the oxidation bath or be re-enhanced, and water is advantageously reinjected into the stop bath and/or the washing baths.

In doing so, the oxidation and waste effluents supply the oxidation bath and advantageously, the different water tanks.

In the method B of carbonation, the residue sludge and/or the waste waters are cleared of hydroxide ions OH⁻, the latter being components of the oxidation bath. According to the invention, the hydroxide ions are transformed into carbonate ions. The corresponding carbonate salts (carbonate ions in the form of salt) are then recovered, then advantageously reinjected into the nitridation bath.

Usually, regeneration salts are injected into the nitridation bath. The latter convert carbonate ions (CO₃)²⁻ in cyanate ions CNO⁻.

Thus, when recycled carbonate ions (CO₃)²⁻ are reinjected into the nitridation bath, they are converted into cyanate ions CNO⁻ by regeneration salts.

Water is advantageously reinjected into the stop bath and/or the rinsing/washing baths.

In doing so, the oxidation and waste effluents supply the nitridation bath and advantageously, the different water tanks, in particular, the washing baths and/or the stop bath.

The re-enhancement of the oxidation salts and the carbonate salts, and if necessary, their recycling, drastically reduces the environmental impact of the industrial nitridation method, by reducing solid and liquid waste, while reusing the latter, in order to supply the method, due to this reducing the quantities and the costs of raw materials, which are oxidising salts and nitridation salts.

The method of the invention therefore offers a double ecological and economic advantage.

It is specified that the parts can only undergo one nitridation, without oxidation, in which case the stop bath serves to stop the nitridation reaction. The method of the invention does not apply to a single nitridation line, without oxidation bath, as in this case, the recovery of carbonates can be done by simply filtering the waste waters.

The nitridation installation can comprise several nitridation baths and/or several oxidation baths and/or several stop baths.

The nitridation installation is used in the present text in its more general acceptance. The different baths that it comprises, can in practice, be installed in a same location or in different locations. For example, the method A can be carried out with a first chemical installation in a first location, and the method B can be carried out with a second chemical installation in a second location, which is different from the first one. Furthermore, a same location can comprise several nitridation installations, i.e. several nitridation lines, each of the installations being able to implement one of the methods A and B or the two methods A and B.

In the method A, the decarbonation step can, in particular, be carried out, in several ways:
decarbonation of only waste waters, or
decarbonation of residue sludge, previously leached in water, or more generally, in an aqueous solution, for example, mains water, or industrial water, or more generally, in an aqueous solution, or
decarbonation of residue sludge, previously leached in the waste waters.

In the method B, the transformation step can, in particular, be carried out, in several ways:
transformation of hydroxide ions OH⁻ of only waste waters, or
transformation of hydroxide ions OH⁻ of residue sludge, with beforehand, a solubilisation of said hydroxide ions OH⁻ by leaching the residue sludge in the water, or more generally, in an aqueous solution, for example, mains water or industrial water, or
transformation of hydroxide ions OH⁻ of residue sludge, with beforehand, a solubilisation of said hydroxide ions OH⁻ by leaching the residue sludge in the waste waters.

According to other aspects, the treatment method according to the invention has the following different features taken individually or according to their technically possible combinations:
decarbonation is done by reaction between the carbonate ions CO₃²⁻ and the monovalent or divalent cations chosen from among: calcium ions Ca²⁺ (CaCO₃ precipitate), lithium Li⁺ (Li₂CaO₃ precipitate), barium Ba²⁺ (BaCO₃ precipitate), magnesium Mg²⁺ (MgCO₃ precipitate), iron (II) Fe²⁺ (FeCO₃ precipitate), copper Cu²⁺ (CuCO₃ precipitate), manganese Mn²⁺ (MnCO₃ precipitate), cobalt Co²⁺ (CoCO₃ precipitate), or their mixtures. Poorly soluble species capable of precipitating in solution are targeted;
decarbonation of the method A is done with hydroxides and/or alkaline and/or alkaline earth metal nitrates, in order to form carbonates of these alkaline and/or alkaline earth metals;
decarbonation of the method A is done with lime Ca(OH)₂ and/or calcium nitrate Ca(NO₃)₂, to form a calcium carbonate CaCO₃ precipitate, according to either of following respective reactions (1) and (2):

[Chem. 1]

Ca(OH)₂+CO₃²⁻→CaCO₃+2OH⁻ (1)

[Chem. 2]

Ca(NO₃)₂+CO₃²⁻→CaCO₃+2NO₃⁻ (2)

Choosing the decarbonation reaction makes it possible to select the carbonate that is sought to be produced (according to the cation used) for enhancement and/or recycling. It is thus possible to adapt the method to the carbonate demand.
the method A of decarbonation further comprises, before the decarbonation step, a step of leaching the residue sludge by adding water;
leaching residue sludge is done at least partially with waste waters;
the method A of decarbonation further comprises, before the decarbonation step, a step of separating metal particles or metal oxides present in the waste waters and/or the residue sludge, for example, by filtration. This makes it possible to optimise the purity of the carbonate precipitate with a view to its re-enhancement;
the step of separating the liquid phase and the solid phase of the method A of decarbonation is carried out by decantation then filtration;
the method A of decarbonation further comprises, after the step of separating the liquid phase and the solid phase, a step of separating water and oxidation salts in the liquid phase, to recover the oxidation salts in solid form;
in the method A of decarbonation, separating water and oxidation salts in the liquid phase is done by drying the liquid phase, for example, in a vacuum evaporator;
the method A of decarbonation further comprises, after the step of separating the liquid phase and the solid phase, a step of reinjecting oxidation salts into the oxidation bath. Preferably, when a separation of water and oxidation salts in the liquid phase to recover the oxidation salts in solid form is done, the step of reinjecting oxidation salts is done after the latter;
the method A of decarbonation further comprises, after separating water and oxidation salts, a step of recycling water to the stop bath and/or at least one washing bath;
the transformation step of the method B is carried out by reaction of hydroxide ions OH⁻ with carbon dioxide CO₂, to form carbonate ions CO₃²⁻ and water, according to the following reaction (3):

[Chem. 3]

2OH^{-+CO}₂→H₂O+CO₃²⁻ (3)
the method B of carbonation comprises, before the transformation of hydroxide ions OH⁻ into carbonate ions CO₃²⁻, a step of separating metal particles or metal oxides present in the waste waters and/or the residue sludge, advantageously by filtration. This makes it possible to optimise the purity of the nitridation salt, since the metal particles are impurities;
the transformation of hydroxide ions OH⁻ in the method B of carbonation is done by insufflation of carbon dioxide CO₂;
the transformation of hydroxide ions OH⁻ in the method B of carbonatation is done by insufflation of air. The hydroxides thus react with the CO₂ present in air. The transformation will take more time, but the method will be simple to implement and less expensive;
in the method B of carbonation, the step of separating water and carbonate salts is carried out by filtering and/or drying;
the method B of carbonation further comprises, after separating water and carbonate salts, a step of recycling water to the stop bath and/or at least one washing bath;
the method B of carbonation further comprises, after separating water and carbonate salts, a step of reinjecting carbonate salts into the nitridation bath;
the method B of carbonation comprises, before reinjecting carbonate salts into the nitridation bath, a step of readjusting contents of cations to the contents of the nitridation bath, to make them compatible with nitridation salts. This steps consists, in practice, of adding alkaline carbonates (for example, lithium, sodium or potassium carbonates) to the carbonate salts obtained, to make their contents correspond to the experimental contents of the carbonate salts in the nitridation bath. It makes it possible to maintain a substantially constant ratio of different cations, or at the very least, limit their variations. This step is therefore quite specifically advantageous, when the carbonate salts are recycled, by reinjecting them into the nitridation bath, since the nitridation bath preserves substantially constant physico-chemical properties over time, which improves the reproducibility of the method;
the nitridation bath comprises cyanate ions CNO⁻ and carbonate ions CO₃²⁻;
the nitridation bath further comprises alkaline ions, preferably lithium ions Li⁺, and/or potassium ions K⁺, and/or sodium ions Na⁺;
the oxidation bath comprises hydroxide ions OH⁻ and/or nitrate ions NO₃⁻, and optionally carbonate ions.

Some carbonate salts produced by the present method can have a significant enhancement potential, like for example, lithium carbonate Li₂CO₃.

An additional advantage of the method B of carbonation is that it makes it possible to trap CO₂.

### DESCRIPTION OF THE FIGURES

Other advantages and features of the invention will appear upon reading the following description given as a non-limiting, illustrative example, in reference to the following accompanying figures:

FIG. 1 is a diagram which illustrates an industrial installation for nitridation in a molten salt bath according to the prior art.

FIG. 2 is a diagram which illustrates an industrial installation for nitridation in a molten salt bath according to the invention, in which only nitridation, oxidation, and stop baths are represented, and in which the recycling loop of oxidation salts is represented.

FIG. 3 is a diagram which illustrates, in detail, the reaction of decarbonation of residue sludge and/or waste waters.

FIG. 4 is a diagram which illustrates an industrial nitridation installation similar to that of FIG. 2, in which the recycling loop of nitridation salts is represented.

FIG. 5 is a diagram which illustrates, in detail, the reaction of transformation of hydroxide ions OH⁻ of residue sludge and/or steep-out waters by insufflation of carbon dioxide CO₂.

FIG. 6 is a diagram which illustrates an industrial nitridation installation similar to that of FIGS. 2 and 4, in which the recycling loop of oxidation salts and the recycling loop of nitridation salts are represented.

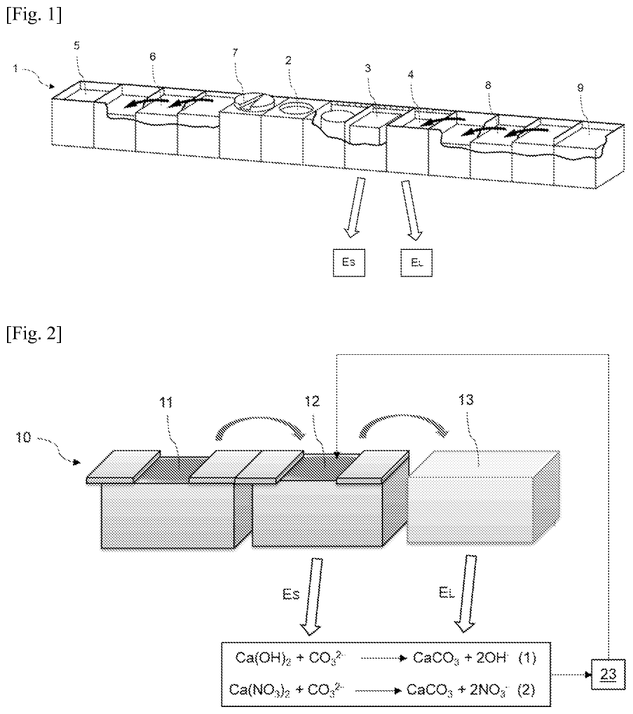

### DETAILED DESCRIPTION OF EMBODIMENTS OF THE INVENTION

The method of the invention will now be described in detail in reference to FIG. 2, which is a simplified representation of a installation 10 for nitridation in a molten salt bath, in that only the main elements of the installation are preserved, namely a nitridation bath 11, and oxidation bath 12, and a stop bath 13, with the aim of simplifying the present text.

The mechanical parts to be treated, previously degreased, then rinsed and dried in an oven, are immersed in the nitridation bath 11. The nitridation bath 11 is composed of molten nitridation salts which are brought to a temperature which is typically between 500° C. and 630° C.

Nitridation aims to give the parts a greater hardness, and to improve their mechanical properties, in particular resistance to seizing and to wear, by diffusion of nitrogen, and optionally carbon in steel, in the case of a nitrocarburising.

The nitridation bath 11 mainly comprises cyanate ions CNO⁻ and carbonate ions CO₃²⁻. Regeneration salts are added if needed in the nitridation bath to rapidly convert the carbonate ions CO₃²⁻ into cyanate ions CNO⁻.

The nitridation bath 11 further comprises alkaline ions, preferably lithium ions Li⁺, and/or potassium ions K⁺, and/or sodium ions Na⁺.

After the nitridation step, the mechanical parts are immersed in the oxidation bath 12. The oxidation bath 12 is composed of molten oxidising salts brought to a temperature typically of around 450° C. The oxidation salts are composed among others of hydroxides.

Oxidation aims to improve resistance to corrosion of parts, and to give them a uniform black appearance.

After the oxidation step, the parts are immersed in the stop bath 13, which contains cold water (waste water), then are cleaned in washing baths, preferably successive cascading washes, before being dried in an oven, then discharged.

As can be seen in FIG. 2, the oxidation of parts generates sludge that is extracted by degreasing the bath, leading to the formation of residue sludge E_{S}, and the stopping water generate waste waters E_{L}, which respectively constitute solid and liquid waste that the method of the invention makes it possible to recycle.

The treatment method according to the invention comprises a method A of decarbonation and a method B of carbonation.

The method A comprises a decarbonation of residue sludge E_{S} and/or of waste waters E_{L} by precipitation of carbonate ions CO₃²⁻.

According to a preferred embodiment of the invention, decarbonation is done by precipitation of carbonate ions CO₃²⁻ of residue sludge E_{S} and/or of waste waters E_{L} with lime Ca(OH)₂ and/or calcium nitrate Ca(NO₃)₂, to form calcium carbonate CaCO₃.

Carbonate ions CO₃²⁻ react with lime Ca(OH)₂ according to the following equation (1):

[Chem. 1]

Ca(OH)₂+CO₃²⁻→CaCO₃+2OH⁻ (1)

Thus, hydroxide ions and calcium carbonate are obtained.

Carbonate ions CO₃²⁻ react with calcium nitrate Ca(NO₃)₂ according to the following equation (2):

[Chem. 2]

Ca(NO₃)₂+CO₃²⁻→CaCO₃+2NO₃⁻ (2)

In this case, nitrate ions and calcium carbonate are obtained.

When lime Ca(OH)₂ and/or calcium nitrate Ca(NO₃)₂ are both added into the reaction medium, the reactions (1) and (2) both occur. Carbonate ions CO₃²⁻ react therefore both with lime Ca(OH)₂ and calcium nitrate Ca(NO₃)₂.

When only lime Ca(OH)₂ is added into the reaction medium, only the reaction (1) occurs. When only calcium nitrate Ca(NO₃)₂ is added into the reaction medium, only the reaction (2) occurs.

After a decantation phase, the liquid phase containing oxidation salts 23 and the solid phase containing calcium carbonate precipitate CaCO₃ are separated. Preferably, the separation is done by filtration, for example on a filter press.

In the liquid phase, then water and oxidation salts are separated, preferably by drying, in order to obtain oxidation salts 23 in solid form.

The oxidation salts 23 in solid form can be preserved to be enhanced, or can be reinjected into the oxidation bath.

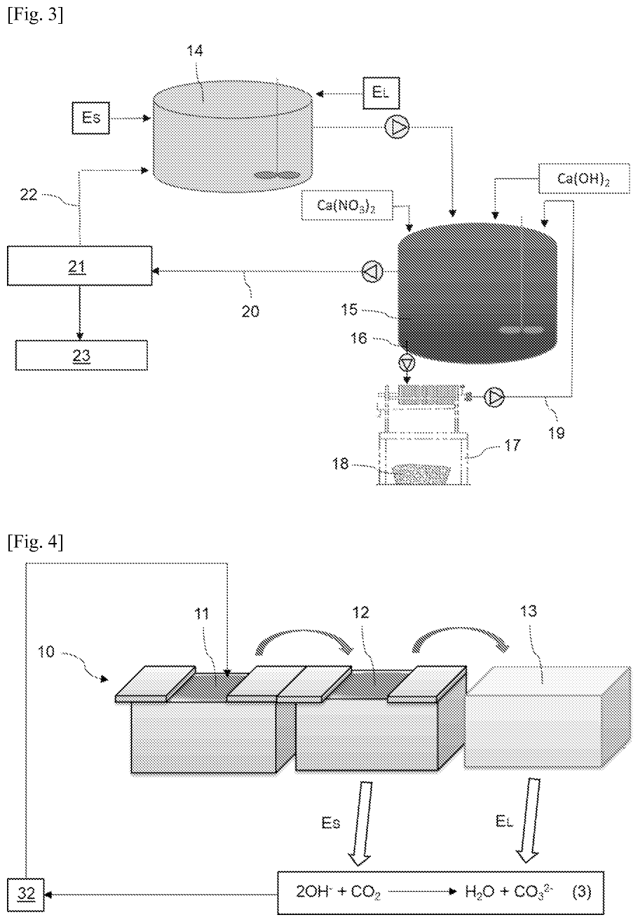

The decarbonation is illustrated in more detail in FIG. 3.

In this figure, the residue sludge E_{S} is put into a solution with the waste waters under stirring in a leaching step. A leaching solution 14 is obtained.

It is specified that the leaching solution 14 can be prepared by solvation of only residue sludge E_{S}, by adding water, or by solvation of residue sludge E_{S} with waste waters E_{L}.

According to a preferred embodiment of the invention, the leaching solution 14 is formed by solvation of residue sludge E_{S} by waste waters E_{L}. This embodiment is particularly advantageous, in that it makes it possible to recycle waste waters E_{L} while using the latter as solvent to solvate the residue sludge E_{S}, which makes it possible to reduce water consumption.

The leaching solution 14 is transferred into a reactor 15, supplied with lime Ca(OH)₂ and/or calcium nitrate Ca(NO₃)₂, and stirred.

A calcium carbonate CaCO₃ precipitate is formed in a solution. The mixture is thus composed of a solid phase, calcium carbonate precipitate CaCO₃, and a liquid phase containing oxidation salts.

After decantation, a solid/liquid separation of the settled solids 16, preferably by filtration of the mixture as FIG. 3 illustrates using a filtration device 17.

The residue 18 comprising calcium carbonate precipitate CaCO₃ is put aside, and can be subsequently enhanced. The filtrate 19 is preferably reinjected into the reactor in order to maximise the yield of the decarbonation.

The supernatant 20 of the reactor is thus transferred into a drying device 21, such as an oven, for example.

Preferably, the drying condensates 22 are reinjected into the leaching solution 14, or in the stop bath, or in the washing baths, in order to reduce water consumption.

Drying makes it possible to obtain recycled oxidation salts 23, which are thus preserved or reinjected into the oxidation bath.

The method B comprises a transformation reaction of the hydroxide ions OH⁻ from the residue sludge and/or from the waste waters, to form carbonate ions CO₃²⁻.

Preferably, the transformation step is carried out by reaction of hydroxide ions OH⁻ with carbon dioxide CO₂, to form carbonate ions CO₃²⁻ and water, according to the following reaction (3):

[Chem. 3]

2OH⁻+CO₂→H₂O+CO₃²⁻ (3)

The carbonate ions CO₃²⁻, referenced 32 in FIG. 4, are then reinjected in the form of salts into the nitridation bath, where they could optionally be converted into cyanate ions CNO⁻ by regeneration salts.

It is also possible to enhance certain carbonates, in particular lithium carbonate. The latter is moreover easily separated from sodium carbonates and potassium by precipitation, thanks to its very low solubility. It can, for example, be recovered after a first decantation followed by a filtering, then the other carbonates are recovered, for example, by drying.

Preferably, before the transformation of hydroxide ions OH⁻into carbonate ions CO₃²⁻, a step of separating metal particles or metal oxides present in the waste waters and/or the residue sludge, advantageously by filtration is carried out, optionally followed by a drying.

Preferably, after the separation of water and carbonate ions CO₃²⁻, a step of recycling water to the stop bath is carried out.

Preferably, before the reinjection of carbonate ions CO₃²⁻ into the nitridation bath, a step of separating carbonate salts and waters is carried out, advantageously by filtration, optionally followed by a drying.

Preferably, before the reinjection of carbonate ions CO₃²⁻ into the nitridation bath, a step of readjusting the contents of the cations to the contents of the nitridation bath is carried out, to make them compatible with the nitridation salts.

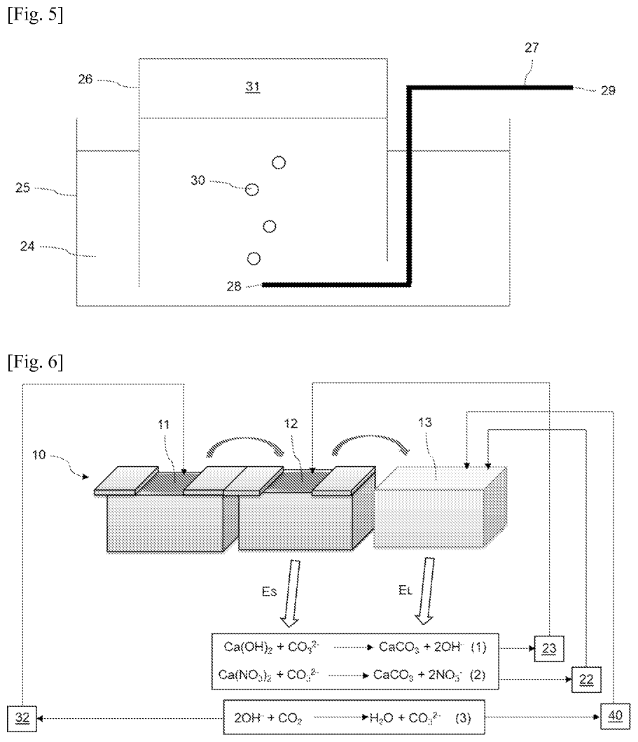

An embodiment of the transformation reaction of the hydroxide ions OH⁻ from the solubilised residue sludge and/or from the waste waters, is illustrated in more detail in FIG. 5. According to this embodiment, the reaction is carried out by carbon dioxide CO₂ insufflation.

In this figure, the waste waters E_{L} and optionally the solubilised residue sludge E_{S} are put into a solution 24 beforehand in a first glass receptacle 25. A second glass receptacle 26 is immersed in the solution 24 in the returned position, so as to make an opening for the passing of a tube 27, between the inside and the outside of the second receptacle 26. The solution 24 thus occupies the volumes of the two receptacles 25, 26. The aim of this installation is to trap carbon dioxide CO₂.

The tube 27 has a first opening 28 opening into the solution inside the second receptacle 26, and a second opening 29 opening onto the carbon dioxide CO₂ supply means outside of the receptacles 25, 26. The tube 27 is thus partially immersed in the solution 24, and passes through the two receptacles 25, 26.

The solution which is located outside of the first receptacle 25 contains hydroxide ions OH⁻ and carbonate ions CO₃²⁻.

Carbon dioxide CO₂ is injected into the second receptacle 26 via the second opening 29 of the tube 27. Carbon dioxide CO₂ bubbles 30 are formed in the solution 24 inside the second receptacle 26. The solution 24 located inside the second receptacle 26 is enriched with carbonate ions CO₃²⁻ from the reaction between carbon dioxide CO₂ and the hydroxide ions OH⁻, and the overlying region 31 is enriched with carbon dioxide CO₂, the latter being trapped by said second receptacle 17.

Subsequently, the carbonate ions CO₃²⁻ can precipitate. Precipitation depends on several parameters that can be adjusted for this purpose, in particular the concentration of the solution in hydroxide ions OH⁻, in carbonate ions CO₃²⁻, and in cations.

According to the formation of the precipitates, water 40 is thus filtered, by means of a filter press for example, then the recovered carbonates are dried. To further recover carbonates (non-precipitates), it can be considered to evaporate water by means of a drier, for example.

Solid carbonates are thus reinjected as nitridation salts in the nitridation bath. To simplify matters, the nitridation salts are, like for the carbonate ions CO₃²⁻, referenced 32 in FIGS. 4 and 6.

Preferably, water 40 is recycled to the stop bath 13.

FIG. 6 illustrates the two recycling loops of the methods A and B, represented separately in FIGS. 2 and 4.

The method according to the invention thus makes it possible, not only to reduce nitridation and oxidation waste, but also to reload the oxidation bath with oxidation salts, and the nitridation bath with nitridation salts, which is conveyed by an economic and ecological recycling, in line with the current environmental standards and technicalities.

1-15. (canceled)

16. A method for treating waste waters or residue sludge, from an oxidation bath, to recover oxidation salts and carbonates, in at least one installation for nitridation in a molten salt bath comprising a nitridation bath, an oxidation bath, and a stop bath, the treatment method comprising:
a method of decarbonation comprising the following steps:
decarbonating waste waters or residue sludge by precipitating carbonate ions, wherein said decarbonation is done by reaction between the carbonate ions and monovalent or divalent cations chosen from among lithium, iron (II), copper, manganese, cobalt, and mixtures thereof, or by reaction with alkaline or alkaline earth metal hydroxides or nitrates, in order to form carbonates of these alkaline or alkaline earth metals,
separating a liquid phase containing oxidation salts and a solid phase containing a carbonate precipitate; and
recovering oxidation salts in the liquid phase, and carbonates in a precipitate form; and
a method of carbonation comprising the following steps:
transforming hydroxide ions of waste waters or residue sludge by reaction of hydroxide ions with carbon dioxide to form carbonate ions and water,
separating water and carbonate salts, wherein the carbonate salts are formed by the carbonate ions and the metal cations from the oxidation salts, and recovering the carbonate salts.

17. The method according to claim 16, wherein decarbonation is done with lime or calcium nitrate to form a calcium carbonate precipitate, according to either of following respective reactions (1) and (2):
Ca(OH)₂+CO₃²⁻→CaCO₃+2OH⁻ (1)
Ca(NO₃)₂+CO₃²⁻→CaCO₃+2NO₃⁻ (2)

18. The method according to claim 16, wherein the decarbonation further comprises, before precipitating carbonate ions, a step of leaching the residue sludge, wherein precipitation is done in the leaching solution.

19. The method according to claim 18, wherein the leaching of the residue sludge is done with the waste waters.

20. The method according to claim 16, wherein the decarbonation further comprises, before decarbonating waste waters or residue sludge, a step of separating metal particles or metal oxides present in the waste waters or the residue sludge.

21. The method according to claim 16, wherein the decarbonation further comprises, after separating the liquid phase and the solid phase, a step of separating water and oxidation salts in the liquid phase, to recover the oxidation salts in solid form.

22. The method according to claim 21, wherein the decarbonation further comprises, after separating water and oxidation salts, a step of recycling water to the stop bath or at least one washing bath.

23. The method according to claim 16, wherein the decarbonation further comprises, after the step of separating the liquid phase and the solid phase, a step of reinjecting oxidation salts into the oxidation bath.

24. The method according to claim 16, wherein the carbonation further comprises, before transforming hydroxide ions into carbonate ions, a step of separating metal particles or metal oxides present in the waste waters or the residue sludge.

25. The method according to claim 16, further comprising, after separating water and carbonate salts, a step of reinjecting carbonate salts into the nitridation bath.

26. The method according to claim 25, wherein the carbonation further comprises, before reinjecting carbonate salts into the nitridation bath, a step of readjusting contents of cations in the carbonate salts to contents of the nitridation bath, to make the carbonate salts compatible with nitridation salts.

27. The method according to claim 16, wherein the carbonation further comprises, after separating water and oxidation salts, a step of recycling water to the stop bath or at least one washing bath.
